(19) United States
(12) Patent Application Publication
(10) Pub. No.: US 2010/0313276 A1
(43) Pub. Date: Dec. 9, 2010

(54) Web-Based Client for Creating and Accessing Protected Content

(75) Inventors: Edward T. Banti, Seattle, WA (US); Steven O. Hubbell, Seattle, WA (US); Mayerber L. Carvalho Neto, Redmond, WA (US); Chandresh K. Jain, Sammamish, WA (US); Mayank Mehta, Redmond, WA (US); Durlabh Malik, Bothell, WA (US); Christopher Barnes, Redmond, WA (US); Michael A. Nelte, Redmond, WA (US); Frank D. Byrum, Seattle, WA (US); Tejas D. Patel, Seattle, WA (US); Yuhui Zhong, Sammamish, WA (US); Amit K. Fulay, Kirkland, WA (US); Gregory Kostal, Kirkland, WA (US); Pankaj M. Kamat, Kirkland, WA (US); Vladimir Yarmolenko, Duvall, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/479,235

(22) Filed: Jun. 5, 2009

(51) Int. Cl. H04L 9/32

(52) U.S. Cl. 726/28

(57) ABSTRACT

A web-based client for creating and accessing protected content may be provided. Consistent with embodiments of the invention, a webmail client may be provided allowing a user to apply a restriction template to a document. The webmail client may be further operative to decrypt and display the document and enforce the restriction against a recipient.

### RELATED APPLICATION(S)

Related U.S. patent application Ser. No. 12/476,049, filed on Jun. 1, 2009 herewith having attorney docket number 14917.1291US01/MS327109.01 and entitled “Business to Business Secure Mail” assigned to the assignee of the present application, is hereby incorporated by reference.

Related U.S. patent application Ser. No. 12/478,608, filed on Jun. 4, 2009 herewith having attorney docket number 14917.1295US01/MS327106.01 and entitled “Transport pipeline decryption for Content-Scanning Agents” assigned to the assignee of the present application, is hereby incorporated by reference.

### BACKGROUND

Persistent document protection is a process for providing browser-based clients with the ability to create and/or view protected content. In some situations, encrypted messages may only be viewed through a locally installed application. For example, a user may need to download an encrypted message and open it with a previously installed client application in order to decrypt the contents. Thus, the conventional strategy is to force users to take additional steps, such as installing additional applications or components, to create and view such encrypted messages. This often causes problems because users may choose not to use encryption or other rights management to avoid the inconvenience of using several different programs or may prevent users from viewing encrypted messages because they don't have access to a client program for their operating platform. For example, a user may not have an appropriate local program installed or such a program may not be supported for their chosen platform.

### SUMMARY

Persistent document protection may be provided. This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

A web-based client for creating and accessing protected content may be provided. Consistent with embodiments of the invention, a webmail client may be provided allowing a user to apply a restriction template to a document. The webmail client may be further operative to decrypt and display the document and enforce the restriction against a recipient.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a flow chart of a method for providing persistent document protection; and

FIG. 3 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Persistent document protection may be provided. Consistent with embodiments of the present invention, a server may be operative to encrypt and/or decrypt content on behalf of a recipient. For example, a user may request access to a protected message via a webmail client. The client application may enforce usage restrictions against the recipient as applied to the message by a sender.

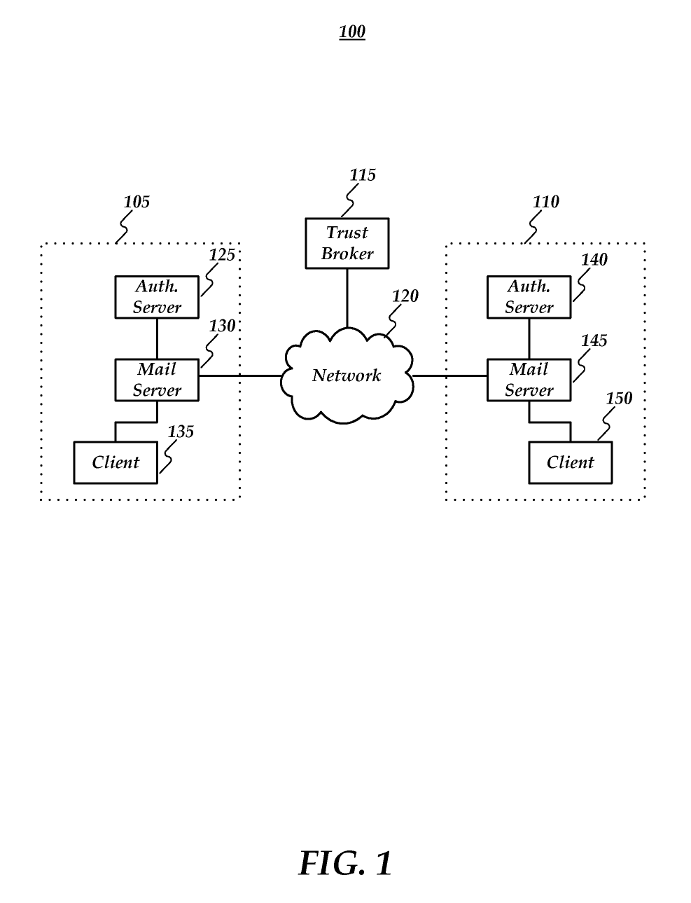

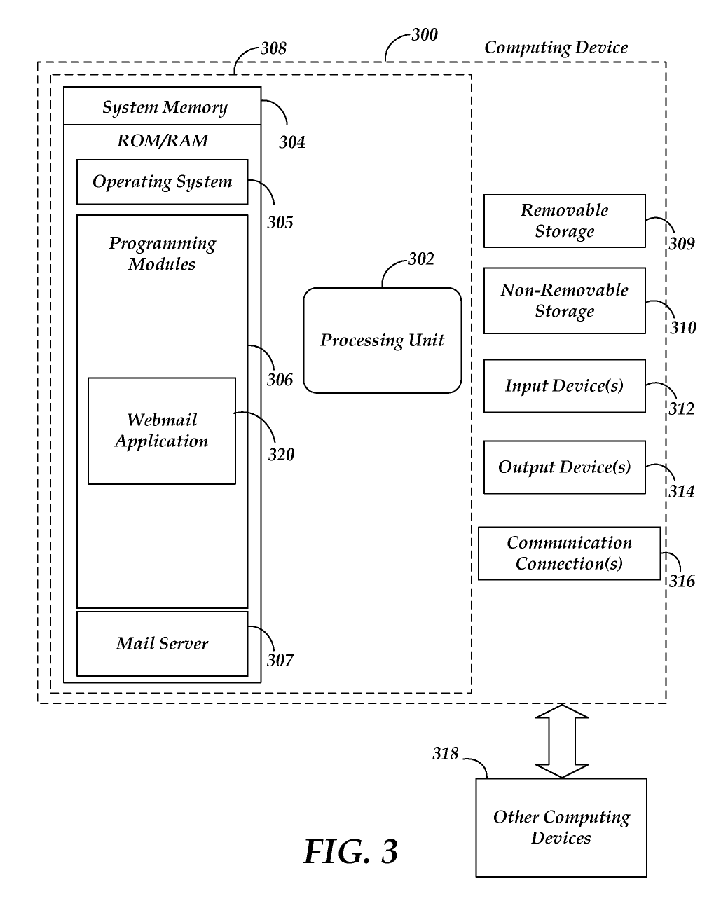

FIG. 1 is a block diagram of an operating environment 100 that may utilize persistent document protection. Operating environment 100 may comprise a first organization 105, a second organization 110, and a trust broker 115 that may communicate via a network 120. First organization 105 may comprise a first authorization server 125, a first mail server 130, and a first client 135. Second organization 110 may comprise a second authorization server 140, a second mail server 145, and a second client 150. For example, trust broker 115 may comprise a Microsoft® Windows Live® federation server, as produced by Microsoft® Corporation of Redmond, Wash. Mail servers 130 and 145 may each comprise an Exchange® server, also produced by Microsoft® Corporation of Redmond, Wash. First authorization server 125 and/or second authorization server 140 may comprise a Windows 2008 Server® also produced by Microsoft® Corporation of Redmond, Wash. First client 135 and/or second client 150 may comprise a computing device such as computing device 300, described below with respect to FIG. 3, used by a sender of a message. Second client 150 may also comprise a computing device used by a recipient of the message. Network 120 may comprise a public network, such as the Internet, a cellular data network, a VPN, or other communication medium. Consistent with embodiments of the invention, second organization 110 may comprise a third party mail hosting organization operative to provide web client access to protected documents exchanged by users within first organization 105.

Second mail server 145 may be operative to receive a protected document, such as an encrypted message, sent by a first user associated with first client 135 to a second user associated with second client 150. The second user may access the message stored on second mail server 145, such as through a web browser application executing on second client 150 communicatively connected to a webmail application executing on second mail server 145. Consistent with embodiments of the invention, second mail server 145 may be operative to prevent access to the message without using the webmail application.

Second mail server 145 may be operative to encrypt and/or decrypt protected documents on behalf of the first user and/or the second user. For example, the first user may access a webmail application executing on first mail server 130 and create a document, such as an e-mail message. First mail server 130 may encrypt the message prior to sending the message over network 120 to second mail server 145. Second mail server 145 may then be operative to decrypt the message on behalf of the second user in order to display the decrypted message in the second user's web browser. Second mail server 145 may be operative to enforce any restrictions applied to the message by the first user and/or first mail server 130. For example, the first user and/or first mail server 130 may select a restriction template operative to prevent the second user from forwarding the message to another user not associated with second organization 110, while first mail server may be operative to apply a restriction to the message preventing the second user from printing the message without including a confidentiality disclaimer. Second mail server 145 may be operative to determine these restrictions and enforce them against the second user, as described more fully below.

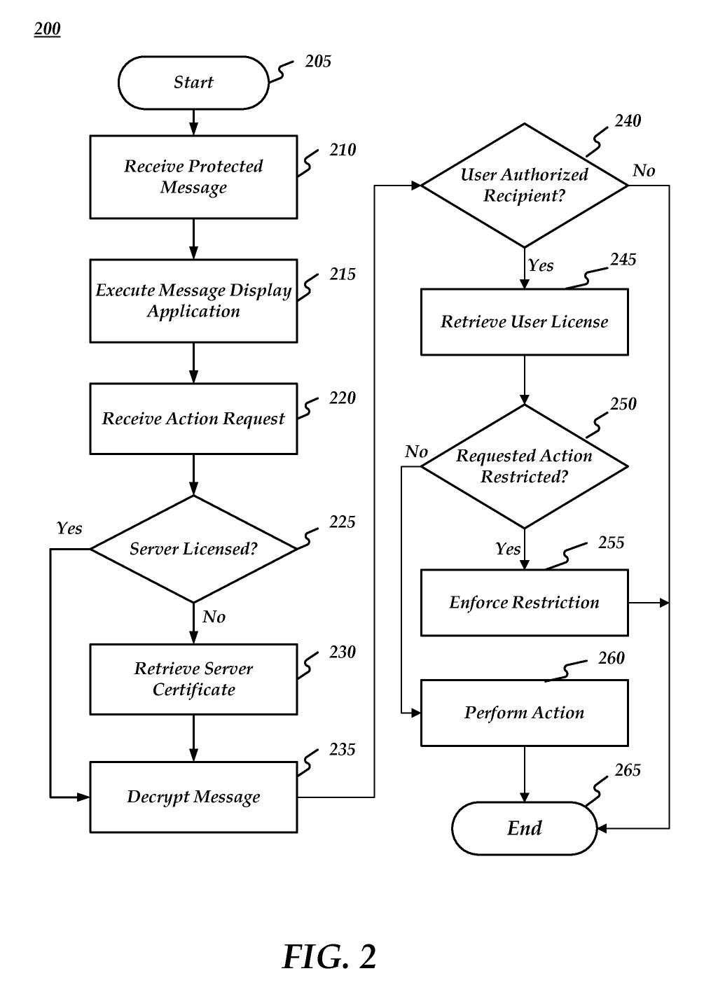

FIG. 2 is a flow chart setting forth the general stages involved in a method 200 consistent with an embodiment of the invention for providing persistent document protection. Method 200 may be implemented using computing device 300 as described in more detail below with respect to FIG. 3. Ways to implement the stages of method 200 will be described in greater detail below. Method 200 may begin at starting block 205 and proceed to stage 210 where computing device 300 may receive a protected document. The protected document may comprise an electronic document such an e-mail message, a word processing document, a spreadsheet, a voice mail message, a presentation, and/or a text message such as a Short Message Service (SMS) message. For example, second mail server 145 may receive an e-mail message created and/or sent by a first user associated with first client 135. Second mail server 145 may determine that the message is protected against an authorization server associated with its own or another organization, such as first authorization server 125 associated with first organization 105 and/or second authorization server 140 associated with second organization 110.

From stage 210, where computing device 300 received the protected message, method 200 may advance to stage 215 where computing device 300 may execute a message display application. For example, second mail server 145 may execute a webmail application operative to allow remote access to messages stored on second mail server 145 via a web browser executing on a client device such as second client 150.

From stage 215, method 200 may advance to stage 220, where computing device 300 may receive a request to perform an action on the protected document. For example, a user may request access to the protected message through the webmail application executing on second mail server 145. Consistent with embodiments of the invention, the user may request to perform other actions such as printing, replying and/or replying to all, editing, forwarding, deleting, and/or copying all and/or part of the message.

From stage 220 where computing device 300 received the request to perform an action, method 200 may advance to stage 225 where computing device 300 may determine whether computing device 300 comprises a server certificate licensing computing device 300 to encrypt and/or decrypt messages protected against a given authorization server, such as first authorization server 125. For example, second mail server 145 may determine whether a server license certificate has previously been retrieved from the appropriate authorization server, such as in response to a previous protected message received from the same organization. The server license certificate may comprise a use license verifying that second mail server 145 is affiliated with a federated organization licensed to process the protected message. The federation process may comprise, for example, verifying the identify of the organization, verifying that the mail server is actually affiliated with that organization and authorized to process protected messages on behalf of users associated with the organization, and/or agreeing to enforce restrictions placed on protected messages received by the organization.

If, at stage 225, computing device 300 determines that computing device 300 is not licensed, method 200 may advance to stage 230 where computing device 300 may retrieve a server license certificate. For example, second mail server 145 may receive a security token from trust broker 115 that verifies the identity of the receiving organization. The security token may then be sent to, for example, first authorization server 125 associated with first organization 105 where first organization 105 comprises a sending organization. First authorization server 125 may return a server certificate for the protected message authorizing and/or enabling second mail server 145 to decrypt the message.

Once computing device 300 retrieves the server license certificate at stage 230 or if computing device 300 determines at stage 225 that the certificate has previously been retrieved, method 200 may advance to stage 235 where computing device 300 may decrypt the message. For example, second mail server 145 may use the retrieved server certificate to produce a decrypted, clear text version of the protected message. Consistent with embodiments of the invention, a decryption key may be stored along with the decrypted message and/or a retained copy of the encrypted message. This may allow the efficient re-encryption of the message at a later time using the same key.

From stage 235, where computing device 300 decrypted the message, method 200 may advance to stage 240 where computing device 300 may determine whether the user requesting the action to be performed is an authorized recipient. An authorized recipient may comprise, for example, a user to whom the message is addressed and/or an agent application operative to scan the message for compliance with the receiving organization's policies, such as an anti-virus, an anti-spam, and/or a journaling agent. If the requesting user is not authorized, method 200 may end at stage 265.

If, at stage 240, computing device 300 determines that the requesting user is authorized to access the protected document, method 200 may advance to stage 245 where computing device 300 may retrieve a license associated with the requesting user. For example, second mail server 145 may request a license for a requesting user associated with second client 150 from first authorization server 125. Consistent with embodiments of the invention, the protected document may comprise a document identifier that may be provided to first authorization server 125 along with a user identifier associated with the requesting user. In this way, authorization server 125 may provide a user license comprising user and message-specific restrictions that second mail server 145 may enforce. For example, a protected message may be sent to a plurality of users. The user license may provide that one of the users may be restricted from any action other than viewing the message while a another one of the users may be restricted only from printing the message. A third one of the users may, for example, be permitted to forward the message, but only if the message content remains unchanged.

The user license may comprise at least one right granted to the user requesting access to the protected document. Rights may comprise actions that may be enabled and/or disabled in an application interface, such as a webmail interface executing on second mail server 145 and accessed through a web browser executing on second client 150. Rights may include, for example, any and/or all of the rights listed in Table 1, below.

TABLE 1

| Right | Description |
|---|---|
| VIEW | If specified, user can view (decrypt) message |
| | contents and attachments. |
| REPLY | If specified, reply action is enabled. |
| REPLY ALL | If specified, reply-all action is enabled. |
| FORWARD | If specified, forward action is enabled. |
| PRINT | If specified, print action is enabled. |
| EXPORT | If specified, user can remove the message's protection. |
| EXTRACT | If specified, text select and copy is enabled. |
| (COPY) | |
| OWNER (FULL | If specified, all actions are enabled. |
| CONTROL) | |

Further consistent with embodiments of the invention, user restrictions may be embedded in the protected document. For example, an X-header may be included in a message comprising instructions to second mail server 145 to enforce restrictions. The instructions may comprise plain-text instructions, (e.g. “X-Enforce: NO FORWARD”) and/or encoded instructions comprising a standardized and/or previously agreed-upon encoding scheme. For another example, instructions may be encoded in the message using eXtensible Rights Markup Language (XrML). The instructions may be encrypted using a key associated with a sending mail server, such as first mail server 130. Consistent with embodiments of the invention, part of the federation process for second organization 110 may comprise an acknowledgment and/or assertion that mail server's associated with second organization 110 may support the encoding scheme.

From stage 245, method 200 may advance to stage 250 where computing device 300 may determine whether the requested action is restricted. For example, second mail server 145 may determine whether a request to print the protected document is forbidden by a restriction associated with the document.

If, at stage 250, computing device 300 determines that the requested action is restricted, method 200 may advance to stage 255 where computing device may enforce the restriction, such as by refusing to perform the requested action. Otherwise, if computing device 300 determines that the requested action is not restricted, method 200 may advance to stage 260 where computing device 300 may perform the requested action. After enforcing the restriction at stage 255 or performing the requested action at stage 260, method 200 may then end at stage 255.

Consistent with embodiments of the invention, method 200 may be implemented with respect to documents, messages, and content sent between users associated with different organizations. Consistent with further embodiments of the invention, method 200 may be implemented internally to an organization and/or enterprise with respect to with respect to documents, messages, and content sent between users associated with the same organization.

An embodiment consistent with the invention may comprise a system for providing persistent document protection. The system may comprise a memory storage and a processing unit coupled to the memory storage. The processing unit may be operative to create a document, select a template comprising at least one restriction, apply the template to the document, send the document to a recipient, and enforce the at least one restriction against the recipient. For example, a first user associated with first client 135 may access a webmail application executing on first mail server 130. The first user may create an e-mail message addressed to a second user associated with second client 150. Before sending the message, the first user may select a template through the webmail interface for applying a restriction to the message that prohibits the second user from printing the message. The print-restriction template may be applied to the message via a property indicating that the message may not be displayed except by a client operative to enforce the restriction. The template may further be applied to attachments associated with the document, such as a word processing document attached to an e-mail message. The restriction may be operative to ensure that the restriction is adhered to by encrypting the message against first authorization server 125, and may thus require second mail server 145 to acquire a server certificate and user license prior to displaying the message. First authorization server 125 may thus be operative to deny the requests for the server certificate and/or the user license and prevent decryption of the message if second mail server 145 will not enforce the restriction. Consistent with embodiments of the invention, message decryption keys may be acquired from authorization servers associated with the sender, the recipient and/or a third party.

The second user may be permitted to send the protected message to at least one other user. Consistent with embodiments of the invention, second mail server 145 may re-encrypt the message prior to sending it to the at least one other user using the same and/or a different encryption key. The re-encrypted message may require the at least one other user to retrieve a server certificate and user license from an authorization server associated with the original sender, the second user, the at least one other user, and/or a third party.

The second user may wish to remove a restriction from the protected document, such as removing a restriction on modifying the document in order to attach a copyright, confidentiality, or disclaimer notice to the message before sending the document to another user. The system may be operative to determine whether the user license grants and/or does not forbid removing the restriction prior to allowing the restriction to be removed.

Another embodiment consistent with the invention may comprise a system for providing persistent document protection. The system may comprise a memory storage and a processing unit coupled to the memory storage. The processing unit may be operative to receive a protected message, receive a request to perform at least one action on the protected document, determine whether the request comprises an authorized request, and in response to determining that the request comprises an authorized request, perform the at least one action on the protected document. The system may be further operative to determine whether the system is operative to perform the requested at least one action, and in response to determining that the server computer is not operative to perform the requested at least one action, provide a message to the at least one client computer comprising an instruction to download at least one second application operative to perform the requested at least one action. For example, the system may be unable to contact the sender's authorization server to retrieve a user license, but may be operative to provide a download link to another application that may be able to display and process the protected document.

Yet another embodiment consistent with the invention may comprise a system for providing secure mail between organizations. The system may comprise a memory storage and a processing unit coupled to the memory storage. The processing unit may be operative to receive, by a server associated with a receiving organization, a protected message from a first user associated with a sending organization, execute a message display application operative to display the protected message and at least one visual indication that the message is protected, receive a request to perform at least one action on the protected message from a client device communicatively connected to the server associated with a second user, determine whether the server comprises a license to process protected messages received from the receiving organization, retrieve a server certificate from an authorization server associated with the sending organization, decrypt the message according to the server certificate, determine whether the second user comprises an authorized recipient of the protected message, retrieve a user license associated with the second user from the authorization server associated with the sending organization, determine whether the requested at least one action comprises the restricted action associated with the message, and enforce the restriction.

FIG. 3 is a block diagram of a system including computing device 300. Consistent with an embodiment of the invention, the aforementioned memory storage and processing unit may be implemented in a computing device, such as computing device 300 of FIG. 3. Any suitable combination of hardware, software, or firmware may be used to implement the memory storage and processing unit. For example, the memory storage and processing unit may be implemented with computing device 300 or any of other computing devices 318, in combination with computing device 300. The aforementioned system, device, and processors are examples and other systems, devices, and processors may comprise the aforementioned memory storage and processing unit, consistent with embodiments of the invention. Furthermore, computing device 300 may comprise an operating environment for system 100 as described above. System 100 may operate in other environments and is not limited to computing device 300.

With reference to FIG. 3, a system consistent with an embodiment of the invention may include a computing device, such as computing device 300. In a basic configuration, computing device 300 may include at least one processing unit 302 and a system memory 304. Depending on the configuration and type of computing device, system memory 304 may comprise, but is not limited to, volatile (e.g. random access memory (RAM)), non-volatile (e.g. read-only memory (ROM)), flash memory, or any combination. System memory 304 may include operating system 305, one or more programming modules 306, and may include a mail server 307. Operating system 305, for example, may be suitable for controlling computing device 300's operation. In one embodiment, programming modules 306 may include a webmail application 320. Furthermore, embodiments of the invention may be practiced in conjunction with a graphics library, other operating systems, or any other application program and is not limited to any particular application or system. This basic configuration is illustrated in FIG. 3 by those components within a dashed line 308.

Computing device 300 may have additional features or functionality. For example, computing device 300 may also include additional data storage devices (removable and/or non-removable) such as, for example, magnetic disks, optical disks, or tape. Such additional storage is illustrated in FIG. 3 by a removable storage 309 and a non-removable storage 310. Computer storage media may include volatile and nonvolatile, removable and non-removable media implemented in any method or technology for storage of information, such as computer readable instructions, data structures, program modules, or other data. System memory 304, removable storage 309, and non-removable storage 310 are all computer storage media examples (i.e memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 300. Any such computer storage media may be part of device 300. Computing device 300 may also have input device(s) 312 such as a keyboard, a mouse, a pen, a sound input device, a touch input device, etc. Output device(s) 314 such as a display, speakers, a printer, etc. may also be included. The aforementioned devices are examples and others may be used.

Computing device 300 may also contain a communication connection 316 that may allow device 300 to communicate with other computing devices 318, such as over a network in a distributed computing environment, for example, an intranet or the Internet. Communication connection 316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 304, including operating system 305. While executing on processing unit 302, programming modules 306 (e.g. webmail application 320) may perform processes including, for example, one or more method 200's stages as described above. The aforementioned process is an example, and processing unit 302 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for applying persistent document protection, the method comprising:
creating a document;
selecting a template comprising at least one restriction;
applying the template to the document;
sending the document to a recipient; and
enforcing the at least one restriction against the recipient.

2. The method of claim 1, wherein the document comprises at least one of the following: a text document, an e-mail, a text message, and a voice mail.

3. The method of claim 1, wherein enforcing the at least one restriction against the recipient comprises:
storing the document on a web server;
providing access to the document via a webmail application; and
preventing the recipient from accessing the document without using the webmail application.

4. The method of claim 1, wherein the at least one restriction comprises a restriction requiring the recipient to acquire a decryption key to view the document.

5. The method of claim 4, wherein requiring the recipient to acquire a decryption key comprises requiring the recipient to acquire the decryption key from at least one of the following: an authorization server associated with a sending organization, an authorization server associated with a receiving organization, a public key server, and a trust broker.

6. The method of claim 1, wherein the at least one restriction comprises at least one of the following: a restriction preventing the document from being sent to at least one second recipient, a restriction preventing the recipient from printing the document, a restriction preventing the recipient from modifying the document, a restriction preventing the recipient from replying to a sender of the message, a restriction preventing the recipient from replying to all recipients of the message, a restriction preventing the recipient from copying at least a part of the document, and a restriction preventing the document from being viewed by a recipient not affiliated with a specified organization.

7. The method of claim 1, further comprising displaying an indicator to the recipient that the document is restricted.

8. The method of claim 6, wherein the indicator comprises an icon associated with a type of the at least one restriction.

9. The method of claim 1, further comprising:
sending the document, by the recipient, to at least one second recipient; and
enforcing the at least one restriction against the at least one second recipient.

10. The method of claim 1, further comprising:
receiving a request from the recipient to remove the at least one restriction from the document;
determining whether the recipient has permission to remove the at least one restriction; and
in response to determining that the recipient has permission to remove the at least one restriction, removing the restriction.

11. The method of claim 10, wherein determining whether the recipient has permission to remove the at least one restriction comprises:
retrieving a license from an authorization server, wherein the license is associated with the template applied to the document; and
determining whether the template comprises permission for the recipient to remove.

12. The method of claim 11, further comprising sending the document to a plurality of recipients, wherein at least one of the plurality of recipients has permission to remove the restriction and wherein at least one of the plurality of recipients does not have permission to remove the restriction.

13. The method of claim 1, further comprising applying the template to at least one attachment of the document.

14. A computer-readable medium which stores a set of instructions which when executed performs a method for providing persistent document protection, the method executed by the set of instructions comprising:
receiving a protected document;
receiving a request to perform at least one action on the protected document;
determining whether the request comprises an authorized request; and
in response to determining that the request comprises an authorized request, performing the at least one action on the protected document.

15. The computer-readable medium of claim 14, wherein the protected document is received from a first user associated with a sending organization and the request to perform the at least one action is received from a second user associated with a receiving organization.

16. The computer-readable medium of claim 15, wherein determining whether the request comprises an authorized request comprises retrieving a license associated with the second user from an authorization server associated with the first user.

17. The computer-readable medium of claim 14, further comprising receiving the request to perform the at least one action on the protected document by a server computer in response to an input by a user received by an application executing on at least one client computer.

18. The computer-readable medium of claim 17, further comprising:
determining whether the server computer is operative to perform the requested at least one action; and
in response to determining that the server computer is not operative to perform the requested at least one action, providing a message to the at least one client computer comprising an instruction to download at least one second application operative to perform the requested at least one action.

19. The computer-readable medium of claim 18, wherein determining whether the server computer is operative to perform the requested at least one action comprises determining whether the server computer is operative to access at least one remotely located authorization server.

20. A system for providing persistent document protection, the system comprising:
a memory storage; and
a processing unit coupled to the memory storage, wherein the processing unit is operative to:
receive, by a server associated with a receiving organization, a protected message from a first user associated with a sending organization;
execute a message display application operative to display the protected message and at least one visual indication that the message is protected, wherein the visual indication is associated with at least one restricted action associated with the message and wherein the restricted action comprises at least one of the following: a restriction preventing the document from being sent to at least one second recipient, a restriction preventing the recipient from printing the document, a restriction preventing the recipient from modifying the document, a restriction preventing the recipient from replying to a sender of the message, a restriction preventing the recipient from replying to all recipients of the message, a restriction preventing the recipient from copying at least a part of the document, and a restriction preventing the document from being viewed by a recipient not affiliated with a specified organization;
receive, via the message display application, a request to perform at least one action on the protected message from a client device communicatively connected to the server associated with a second user, wherein the second user is associated with the receiving organization;
determine whether the server comprises a license to process protected messages received from the receiving organization;
in response to determining that the server does not comprises a license to process protected messages received from the receiving organization, retrieve a server certificate from an authorization server associated with the sending organization;
decrypt the message according to the server certificate;
determine whether the second user comprises an authorized recipient of the protected message;
in response to determining that the second user comprises an authorized recipient of the protected message, retrieve a user license associated with the second user from the authorization server associated with the sending organization;
determine whether the requested at least one action comprises the restricted action associated with the message, wherein the restricted message associated with the message is associated with a template applied to the protected message by at least one of the following: the first user and the sending organization; and
in response to determining that the request comprises a restricted action, enforce the restriction, wherein being operative to enforce the restriction comprises being operative to refuse to perform the requested action.
